(19) United States
(12) Patent Application Publication
(10) Pub. No.: US 2014/0100922 A1
(43) Pub. Date: Apr. 10, 2014

(54) EMPLOYEE ENGAGEMENT SYSTEM, METHOD AND COMPUTER READABLE MEDIA

(71) Applicant: Aaron B. Aycock, Sugar Hill, GA (US)

(72) Inventor: Aaron B. Aycock, Sugar Hill, GA (US)

(21) Appl. No.: 13/794,736

(22) Filed: Mar. 11, 2013

Related U.S. Application Data
(60) Provisional application No. 61/609,335, filed on Mar. 11, 2012.

(51) Int. Cl. G06Q 10/06

(52) U.S. Cl. CPC G06Q 10/0639
USPC 705/7.38

(57) ABSTRACT

One embodiment includes employee engagement software instructions encoded on a nontransitory computer readable medium that, when executed, cause a processor to perform operations that permit a company to measure both employee sentiment and employee performance and combine these two to generate a real-time employee engagement score.

### RELATED APPLICATIONS

This application claims the benefit of U.S. Provisional Application No. 61/609,335, entitled “Employee Engagement System, Method and Computer Readable Media” and filed on Mar. 11, 2013, which is incorporated herein by reference in its entirety.

### FIELD

Embodiments relate generally to business information systems, more particularly, to business management systems, methods and computer readable media for employee performance management.

### BACKGROUND

Conventional methods for measuring employee engagement usually include conducting employee sentiment surveys. There can be large delays between drafting the survey, distributing the survey, gathering survey responses, analyzing the collected data, and presenting the results. Given the amount of effort required, employee sentiment surveys are often only conducted annually.

Further, even after gathering employee sentiment survey results, a critical component of employee engagement, employee performance, may be missing.

Embodiments were conceived in light of the above-mentioned limitations, among other things. In order to measure employee engagement, companies may desire a system that ties employee sentiment to employee performance to generate a composite measure.

### SUMMARY

One embodiment includes employee engagement software instructions encoded on a nontransitory computer readable medium that, when executed, cause a processor to perform operations that permit a company to measure both employee sentiment and employee performance and combine these two to generate a real-time employee engagement score.

### BRIEF DESCRIPTION OF THE DRAWINGS

FIG. 1 is an exemplary manager's view of composite engagement scores for a team in accordance with at least one embodiment.

FIG. 2 is an exemplary executive's view of employee sentiment vs. contribution over time (animated time series) in accordance with at least one embodiment.

FIG. 3 is an exemplary executive's view of the animated time series scatter plot after the user has paused the animation and selected an individual data point to display drill down detail in accordance with at least one embodiment.

FIG. 4 is an exemplary time-series view of employee sentiment and/or contribution in accordance with at least one embodiment.

FIG. 5 is an exemplary manager's view of manual employee sentiment data capture in accordance with at least one embodiment.

FIG. 6 is an exemplary manager's view of automated employee sentiment data capture configuration in accordance with at least one embodiment.

FIG. 7 is an exemplary user's view of a scorecard of metrics tied to employee performance goals in accordance with at least one embodiment.

FIG. 8 is a flow chart of an example method for employee engagement in accordance with at least one embodiment.

FIG. 9 is a diagram of an example employee engagement system in accordance with at least one embodiment.

### DETAILED DESCRIPTION

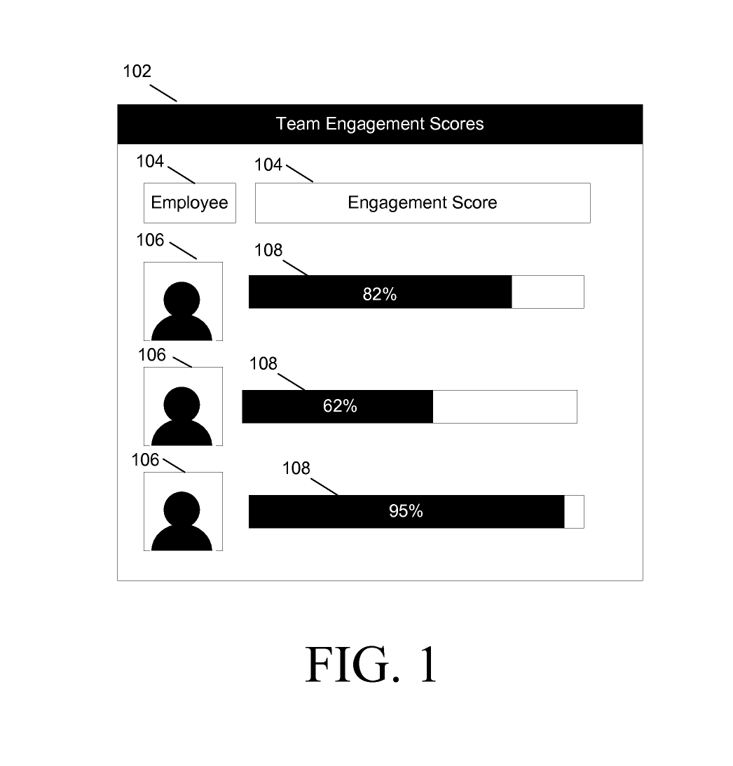

Referring now to an exemplary embodiment in more detail, in FIG. 1 there is shown a manager's view of composite engagement scores (normalized to a 100-point scale) that are calculated by combining employee sentiment data and employee contribution data (such as goal progress, metric performance, and task completion statistics).

The manager's view user interface includes a “Team Engagement Scores” content box (102) as displayed in a web browser (e.g., rendered using HTML and CSS). The interface also includes column headers 104 to indicate employee names and employee engagement scores. An employee avatar (or personalized photo) 106 is displayed along with employee name. A horizontal bar chart 108 indicates relative engagement scores. Engagement scores can be normalized to 100 or may use a custom scale.

Employee contribution measures are quantitative in nature and consist of goals, metrics and task completion data. Goal progress can be captured as percentage complete or binary yes/no achievements. Metrics are captured as a percentage of target value. Task completion can be measured as percentage of tasks complete and timeliness of completion as measured by distance in time between target deadline and actual completion date.

Employee contribution data can be scored on a 0 to 100 point scale. A score of 0 represents no progress toward goal achievement, no progress towards metric target values and all assigned tasks incomplete. A score of 100% represents achievement of each goal, metric values that meet or exceed target values, and completion of all assigned tasks by deadline.

Employee sentiment data is qualitative in nature and is captured using surveys delivered to the employee. There are a number of channels that can be used to deliver a survey. The first channel is a direct question delivered by the system and presented in the meeting planner module. The question most frequently used is “How was your week” and is captured using a 5-point scale. The system also allows custom surveys to be delivered using a scheduler. The scheduler can be set to deliver all questions at once, or deliver one question at a time over a configurable time frame.

To create a custom survey, the user will create a group of questions, select the target audience and select a timeframe for the survey to be delivered. For each question, the user can select a scale (3 point scale, 5 point scale, yes/no, yes/no/maybe, free form, etc.) and directionality (higher is better, yes is better, etc.).

When the scheduler delivers a survey question to an employee, the employee receives a notification email and an alert in the system with a link to the survey response page. When the recipient completes the response, the creator of the survey receives a notification email and an alert in the system as well.

In response to a request to view one or more composite engagement scores, or one or components thereof, the scores can be calculated in real time based on survey responses that have been received. Alternatively the scores can be calculated in advance, e.g., in order to generate alerts the scores can be calculated in advance, for example via batch processing.

The qualitative employee sentiment data can be normalized to a 100 point scale depending on the nature of surveys used. Because surveys can be customized, a 100 can represent the highest possible score on all surveys delivered and completed by the employee.

Because organizations value performance and sentiment factors differently, the system allows for custom weighting of each factor in determining the individual contribution and sentiment scores. The composite score can be a weighted average of the contribution and sentiment scores.

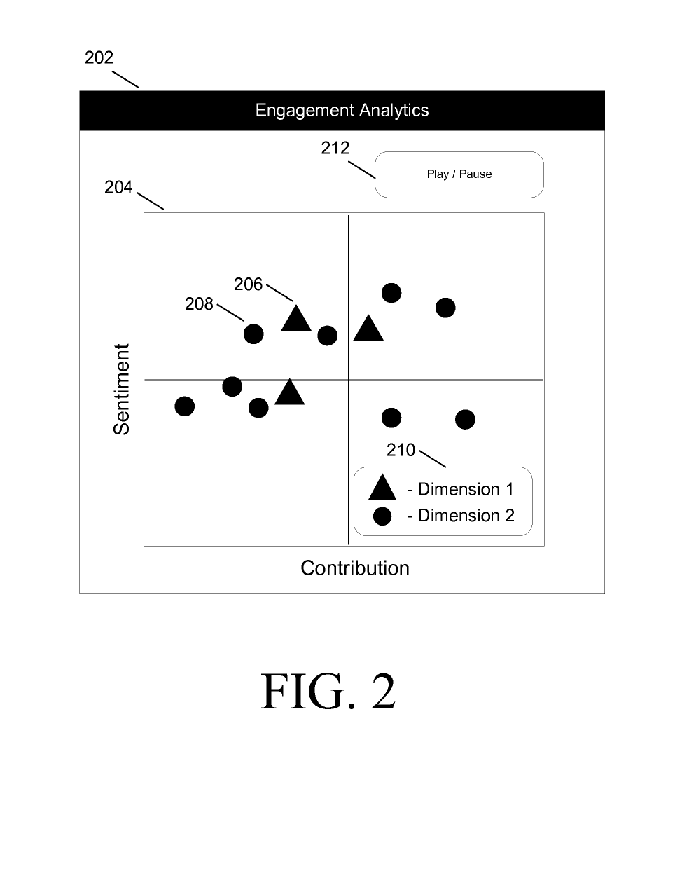

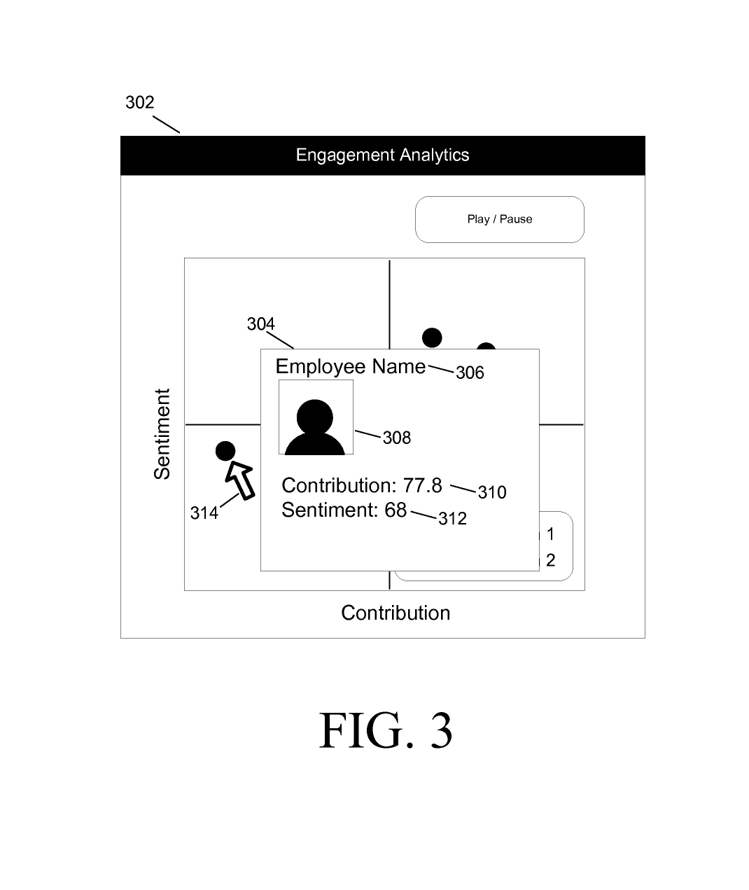

FIG. 2 shows an executive's view of a time series scatter plot. It can be animated to show trends over time for calculated and available data. Also, the plot can contain a pause/play toggle button. Each data point on the chart can represent, for example, an individual employee which can be clickable for additional drill down detail (refer to FIG. 3).

In FIG. 2, an “Engagement Analytics” content box 102 user interface can be displayed in a web browser (e.g., rendered using HTML and CSS). The interface includes a scatter plot 204 having two dimensions: contribution and sentiment. Along the y-axis, higher values represent higher sentiment data. Along the x-axis, higher values represent higher contribution data.

Each plotted point 206 represents an individual employee. The symbol used to plot can represent a third dimension of data, such as office location, tenure, pay grade, or any other demographic data.

A plotted point 208 with slightly lower contribution data values and slightly lower sentiment data values than the point represented by 206. This plotted point also represents a different value for third dimension.

The interface can include plot legend for symbols mapped to third dimension values 210. One example might be office location. The circle symbol could represent an office in New York, N.Y. and the triangle symbol could represent an office in Atlanta, Ga.

A play/pause toggle button 212 allows the scatter plot to be animated over time series which shows engagement data trends over time.

FIG. 3 depicts real-time engagement analytics. It is a time-series scatter plot. The x axis represents employee sentiment. The y axis represents employee contribution. Each data point represents an employee. Colors and symbols can be used to depict additional data dimensions such as office location, tenure, sex, hiring cohorts, or any other demographic data. The chart is animated and loops through historical data, rendering the chart title and data to reflect monthly snapshots over time. In this figure, the user has selected a data point, which represents a specific employee. Engagement score details are the displayed in a model, pop-up window.

FIG. 3 shows an “Engagement Analytics” content box 302 as displayed in a web browser, (e.g., rendered using HTML and CSS). A modal popup 304, rendered in HTML and CSS shows individual employee details for engagement score components (sentiment and contribution score values). A label 306 indicates the name of the employee represented by the scatter plot point that the cursor is currently hovering over. The avatar 308 of the employee represented by the scatter plot point that the cursor is currently hovering over. The contribution score 310 for the employee represented by the scatter plot point that the cursor is currently hovering over.

The sentiment score 312 is shown for the employee represented by the scatter plot point that the cursor is currently hovering over. The mouse cursor 314 is shown as rendered by the operating system and web browser. Here it is shown hovering over a specific scatter plot point that represents a specific employee.

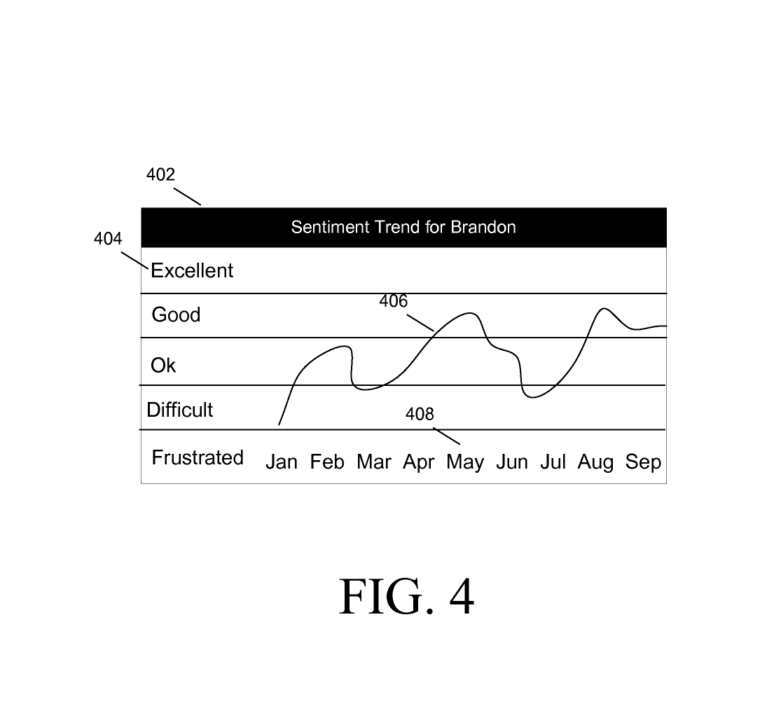

FIG. 4 depicts employee sentiment data over time. In this example, the historical data represents the employee's responses to the question “How was your week?” on a weekly basis using all historical data available.

A “Sentiment Trend” content box 402 is shown as displayed in a web browser (e.g., rendered using HTML and CSS).

FIG. 4 also shows a Sentiment value scale 404. Sentiment data can be captured and evaluated using a custom, named scale. In this example, sentiment is categorized into one of 5 values—Frustrated, Difficult, Ok, Good, and Excellent.

A line graph 406 representing sentiment data captured for a specific employee is plotted to reflect the category values over time. The X-Axis 408 represents time frame.

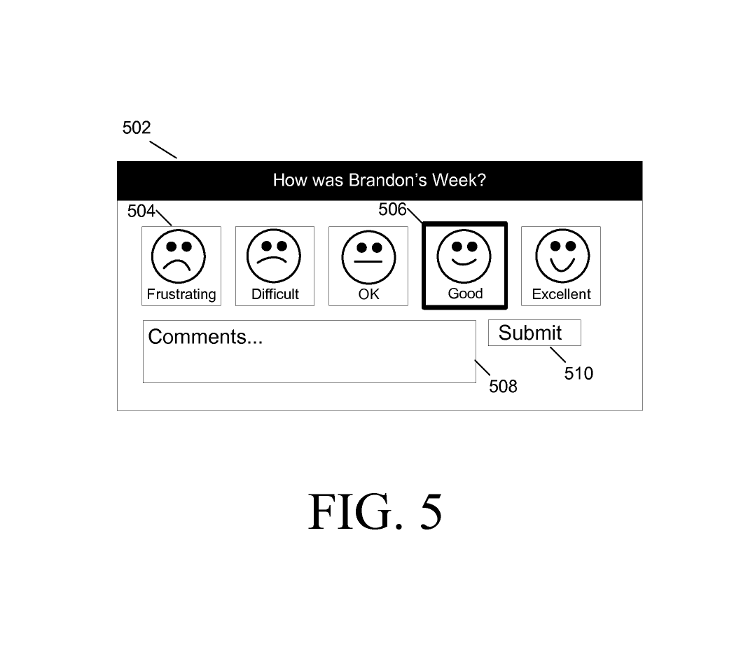

As shown in FIG. 5, a manager is given the ability to capture their perception of employee sentiment during a one-on-one meeting. The employee may also submit sentiment data. The scale can be customizable from binary (good/bad) to a 5 point scale or 10 point scale, for example.

An interface for a “Sentiment Capture” content box 502 is shown as displayed in a web browser (e.g., rendered using HTML and CSS). Buttons 504 with icons used to represent sentiment value scale are shown. Employees may click the button that represents their current sentiment.

When a sentiment value is selected, the clicked button 506 is highlighted to indicate selection. A comment text area 508 allows employees to add free form notes along with sentiment value selection. An HTML submit button 510 can be used to transfer sentiment selection value and free-form comment text to the processing server.

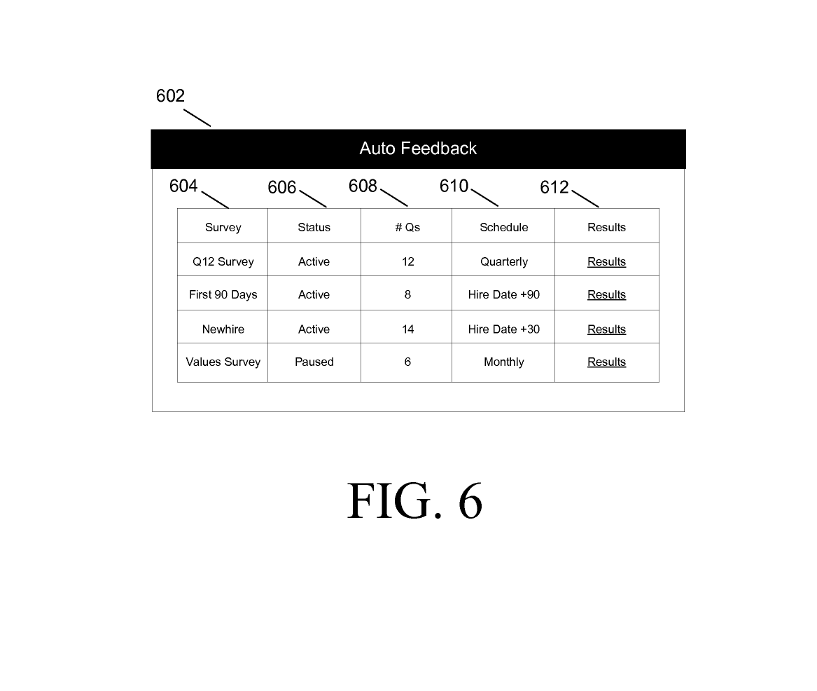

As shown in FIG. 6, the system can be used to schedule custom questions to be delivered to users. It automatically gathers feedback responses and calculates results. An existing framework of questions can also be used and we allow a number of standard frameworks to be implemented. Examples of these question frameworks include the Q12 survey framework from the Gallup organization and the set of manager-employee questions recommended in the First90 Days by Michael Watkins.

An interface for an “Auto Feedback” content box 602 is shown as displayed in a web browser (e.g., rendered using HTML and CSS). A “Survey Name” column header 604 is shown for a table that contains all surveys added to capture auto-feedback. Each survey must be uniquely named. A “Status” column header 606 is shown. Auto feedback is designed to capture survey results automatically when the status is active. When the status is inactive, automatic gathering of survey results will be suspended.

A “Number of Questions” column header 608 is shown. Surveys can be customized and may contain any number of questions. The values in this column represent the number of questions on a particular survey.

A “Schedule” column header 610 is shown. Survey results can be captured on a specified schedule. The values in this column represent the frequency or automatic schedule of a particular survey. A “Results” column header 612 is shown. This column contains links to survey results that have already been captured for a particular survey.

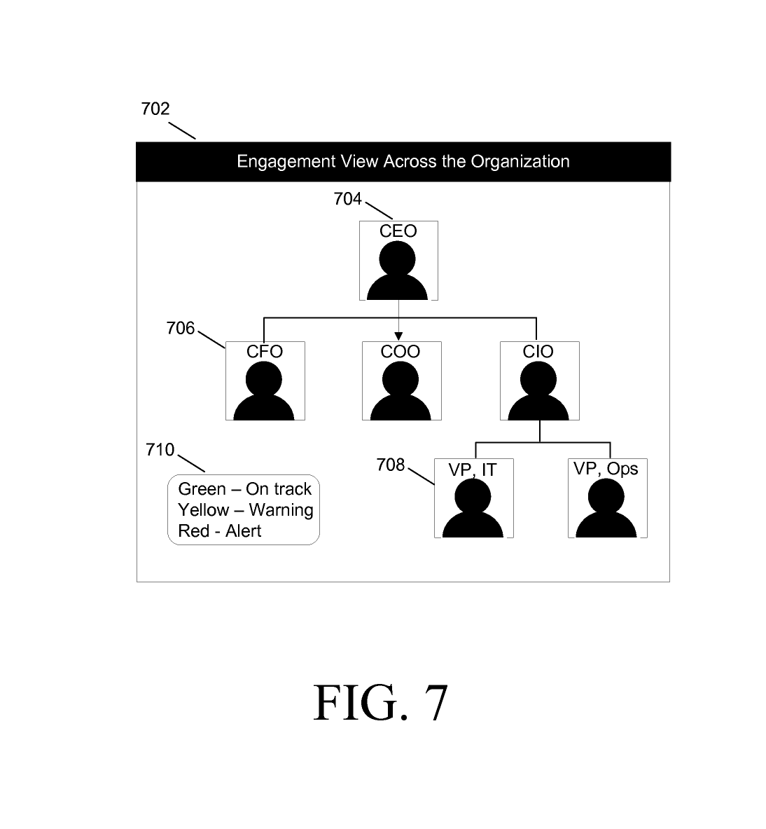

FIG. 7 depicts a scorecard, which is used to logically group a set of metrics to track progress quickly. It is a table that displays metric name, a sparkline summary of historical trends, the current value, the change in value (nominally and as a percentage), and any comments associated with the last update. It also features dynamic highlighting that displays green arrow indicators for favorable changes, red arrow indicators for unfavorable changes, red/yellow/green indicators for performance relative to warning/alert/goal thresholds, and highlighting of last date updated to indicate metrics which are past-due for scheduled updates.

An interface for an “Auto Feedback” content box 702 is shown as displayed in a web browser (e.g., rendered using HTML and CSS).

An organization-wide view 704 of engagement scores is shown starting with the CEO (or top-level departments) and cascading down the organizational hierarchy. Each node represents an individual employee, and each node is color coded with a value of red, yellow, or green.

At the middle tiers of the organizational hierarchy 706, engagement values are summarized by aggregating engagement scores from down-line employees (employees that are lower in the reporting structure). At the lowest displayed level of hierarchy 708, users can click to drill down further into the organizational hierarchy. In this example, clicking on “VP, IT” will display the next 3 hierarchy levels below this position, including direct report employees and their direct report employees.

A legend key 710 represents how color coding maps to engagement score values.

The system generates a number of visualizations of engagement composite scores and performance/sentiment component scores. The system generates an organizational view where the colors are based on corresponding ranges of scores. For example, gray can indicate “Not Applicable” and colors can indicate scores within the corresponding ranges of scores.

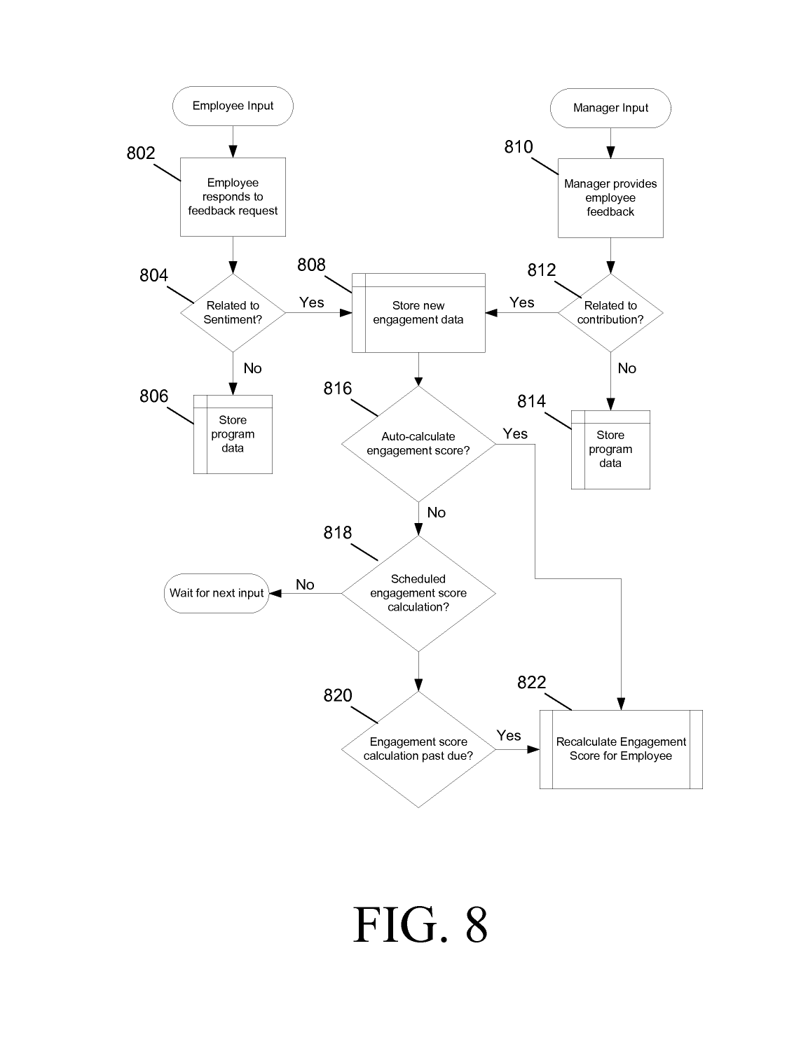

FIG. 8 is a flow chart of an example method. Processing begins at 802, where feedback data can be captured from employees. In this request flow, an employee has responded to a request for feedback within the system. Processing continues to 804.

At 804, the system determines if this type of feedback request is related to sentiment.

At 806, if the data captured is not related to sentiment, the data is stored and no further processing is required. At 808, if the data captured from the employee is related to sentiment, the data is stored as new engagement data.

At 810, feedback data can also be captured from managers related to a specific employee. In this request flow, a manager has provided feedback for a specific employee.

At 812, the system determines if this feedback data is related to contribution.

At 814, if the data captured is not related to contribution, the data is stored and no further processing is required.

At 808, if the data captured is related to contribution, the data is stored as new engagement data.

At 816, when new engagement data is stored, system determines if system is configured for auto-calculating engagement scores for employees. If the system is configured for auto-calculation, processing continues to 822, “Recalculate Engagement Score for Employee”.

At 818, if the system is not configured to auto-calculate engagement scores, then system determines if system configured to calculate on a configured schedule. If the system is not configured for scheduled calculation, then it is assumed that system requires manual requests for calculation and no further processing required.

At 820, if system is configured for scheduled calculation, then system determines if scheduled calculation is past-due. If not, no further processing required. If so, continue to to 822, “Recalculate Engagement Score for Employee”.

At 822, the system will begin the process of calculating the new engagement scores using any recently captured engagement data (both sentiment and contribution). To calculate the engagement score, the system first calculates component scores for sentiment and contribution. Sentiment and contribution scores are normalized on a 100-point scale. Once normalized, an algorithm using customizable weights for each type of score components determines average scores for both components (sentiment and contribution). With normalized component scores, the system will combine the component scores into both a raw and average aggregate engagement score. This aggregate score represents the overall engagement score for an employee.

An implementation of the embodiment shown in FIG. 1 can include a web-based language capable of interpreting HTTP POST and GET requests and responding with HTTP payloads that include HTML, CSS, Javascript and images. The implementation can also include a relational database backend to persist profile, configuration, and operational data.

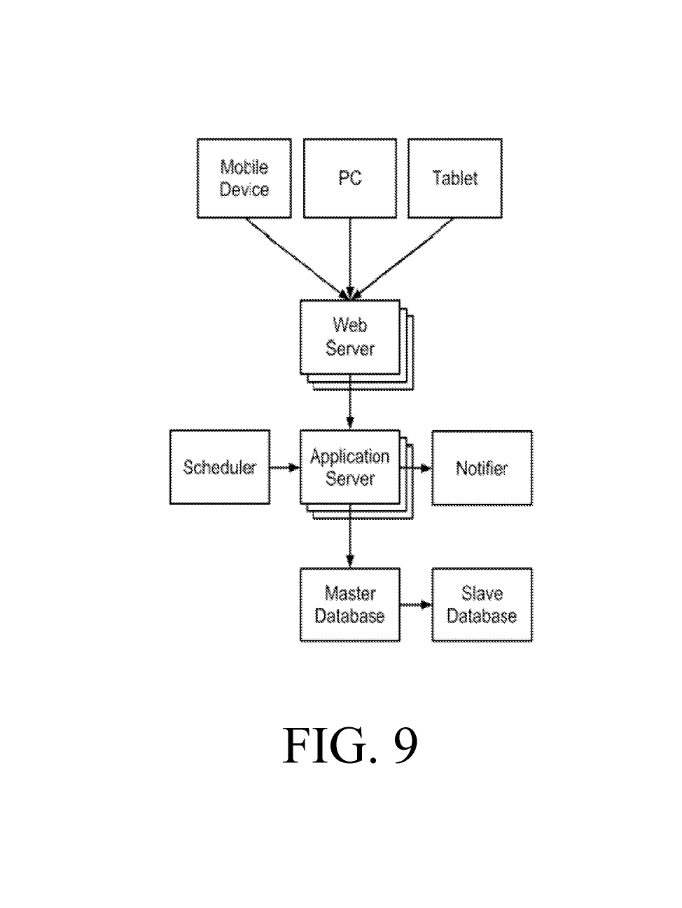

FIG. 9 shows an example employee engagement system in accordance with at least one embodiment. The web server and/or application server can include a single server computer, a distributed server computer, a cloud computing system or any computing system suitable for performing server functions. In general, any computing device capable of being programmed to perform server function in accordance with the present disclosure can be used. The master/slave database can be PostgreSQL or the like.

User devices (examples shown in the figure above as mobile device, PC and tablet) can include computers programmed to perform employee engagement functions described herein. For example, user devices can include a wireless phone (e.g., an Apple iPhone, a feature phone, a smart phone or the like), a personal digital assistant (e.g., a Blackberry, a Palm OS Device, a Windows Mobile device or the like), a portable computer (e.g., a laptop, netbook, notepad computer, tablet computer, Apple iPad, palm top computer or the like), an ebook reader (e.g., Amazon Kindle, Barnes and Noble Nook, Sony ebook reader or the like), a portable media player (e.g., Apple iTouch or the like), a desktop computer (e.g., a PC-compatible, an Apple Macintosh, or the like) or other suitable computing device. In general, any computing device capable of being programmed to perform the functions in accordance with the present disclosure and as described herein can be used.

Feedback responses can be automatically parsed from an email reply to a survey that was emailed to an employee. In other words, the responses can be automatically extracted from a reply email by a computer and stored in an employee engagement system database without the employee having to directly access the employee engagement system.

In addition to managing employees, an embodiment of the systems, methods and computer readable media described herein can be used with other organizations (e.g., non-profits, schools) and other classifications of people, such as volunteers, contractors, students. An embodiment can be used anywhere where measuring performance and sentiment may be desired.

### Data Model

User (id, first_name, last_name, sentiment_score, contribution_score, engagement_score)

The user record captures important data to uniquely identify each user. Goals, Metrics, Feedback, Reviews, and other objects are all owned by a unique user and store the owner's user ID.

Engagement_History(date, user_id, sentiment_score, contribution_score, engagement_score) Engagement history records track contribution, sentiment, and composite scores over time to allow for animated time-series charting. History data can be used for trend analysis.

Feedback(user_id, recipient_id, date, feedback_type, survey_id, date, value) Feedback records track communication in the form of feedback from user to user or system to user. These records can capture positive feedback, constructive critical feedback, 360 degree feedback, and sentiment survey feedback in the form of questions and responses.

Metrics(metric_id, metric_name, owner_id, goal_id, directionality, unit_type) Metric records capture metrics created to track progress quantitatively. They are always created and owned by a unique user and are often associated with goal records. Metric records also capture the units measured (percentage, dollars, time, generic units) and directionality (higher is better, lower is better, etc.).

Metric_values(metric_value_id, metric_id, datetime, value, comment) Metric value records capture metric performance over time.

An embodiment can permit employee engagement to be calculated near real-time by measuring and combining both employee sentiment data and employee contribution data in a composite score that can be calculated on-demand or at any intervals (e.g., daily, weekly, monthly, or the like).

In another embodiment, an employee engagement score can be calculated by combining employee sentiment data and employee contribution data as collected by a system used by both managers and employees.

It will be appreciated that the modules, processes, systems, and sections described above can be implemented in hardware, hardware programmed by software, software instructions stored on a nontransitory computer readable medium or a combination of the above.

An employee engagement computer system, for example, can include a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as C/C++, Java, Javascript, .Net, Perl, Python, Ruby (or Ruby on Rails), Tcl, ODBC, C#.net, assembly or the like. The instructions can also comprise code and data objects provided in accordance with, for example, the Visual Basic™ language, or another structured or object-oriented programming language. The sequence of programmed instructions, or programmable logic device configuration software, and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Exemplary structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering arts.

Moreover, embodiments of the disclosed method, system, and computer program product can be implemented in software executed on a programmed general purpose computer, a special purpose computer, a microprocessor, or the like.

It is, therefore, apparent that there is provided, in accordance with the various embodiments disclosed herein, employee engagement computer systems, methods and computer readable media.

While the invention has been described in conjunction with a number of embodiments, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the invention.

What is claimed is:

1. A method comprising:
obtaining, using one or more processors, employee sentiment data;
obtaining, using the one or more processors, employee performance data; and
combining, using the one or more processors, the employee sentiment data and the employee performance data to generate a real-time employee engagement score.
